(19) United States
(12) Patent Application Publication
(10) Pub. No.: US 2026/0242089 A1
(43) Pub. Date: Aug. 20, 2026

(54) HANDHELD HOT STAMPING APPARATUS

(71) Applicant: Baoding Cultural Products (Shenzhen) Co., Ltd., Shenzhen Guangdong (CN)

(72) Inventor: Yongjian Liang, Shenzhen Guangdong (CN)

(73) Assignee: Baoding Cultural Products (Shenzhen) Co., Ltd., Shenzhen Guangdong (CN)

(21) Appl. No.: 19/056,820

(22) Filed: Feb. 19, 2025

(51) Int. Cl. B65C 5/02

(52) U.S. Cl. CPC B65C 5/02

(57) ABSTRACT

A handheld hot stamping apparatus is provided, including a heating plate, a heat-conducting plate, and a connecting piece. The connecting piece connects the heating plate and the heat-conducting plate, and also allows the heat-conducting plate to be detached from the state of being connected to the heating plate. A melting temperature required for the hot stamping label is provided by the heating plate, which transfers the melting temperature to the hot stamping label through the heat-conducting plate. After holding the hot stamping apparatus until the hot melt adhesive of the hot stamping label is completely melted, or placing the hot stamping apparatus beside the workbench and waiting for the hot melt adhesive of the hot stamping label to be completely melted by users, the heat-conducting plate and the hot stamping label are pressed on the clothing.

### TECHNICAL FIELD

The present disclosure relates to the technical field of small handheld thermal transfer printing, and in particular, to a handheld hot stamping apparatus.

### BACKGROUND

At present, handheld hot stamping machines in the industry need to meet two conditions when fixing a hot stamp label on clothing: sufficient temperature to melt the hot melt adhesive, and sufficient pressing time and force to make the hot stamping label stay on the clothing. In addition, handheld hot stamping machines are mainly used by individuals, specifically operated by individuals for DIY operations and for fixing hot stamping labels on the clothing other than in factory batches.

For the products currently disclosed on Taobao, the handheld hot stamping machine needs to press hard to iron the hot stamp label on the clothes to prevent the hot stamp label from shifting, resulting in poor hot stamping effect; moreover, it takes at least 2-5 minutes to completely melt the hot melt adhesive, so the pressing time is at least 2-5 minutes to fix the hot stamping label on the clothing; refer to the Taobao public product link http://e.tb.cn/h.TXvb8tWLGVrWw4t?tk=Hi8E3Gg8QWx CZ0012.

The hot stamping label needs to be placed on the clothing first, and the ironing machine presses on the hot stamping label to give temperature for the hot stamping label and pressure on the clothing with force and time. Therefore, it is difficult for individual DIY operations to stably achieve the effect of hot stamping the complete hot stamping label. The handheld ironing machine working at this time cannot do other work any longer, and the efficiency is extremely low.

For the current industrial thermal transfer equipment, for example, the Chinese patent with publication No. CN204687552U discloses a new press-down type heat press machine, which uses a spring fixing seat to connect with a heat press board. When the quick clamp is pressed down, the spring is compressed, and the heat press board connected to the spring fixing seat is compressed; the temperature control display part adopts digital temperature control timing and automatic alarm, which is more convenient to use; although it is efficient, it cannot be used for individual DIY operations.

The aforementioned thermal transfer printing technology has a low efficiency and it is difficult for individual DIY operations to stably achieve the effect of hot stamping the complete hot stamping label. It is necessary to design a handheld hot stamping apparatus to solve the aforementioned problems.

### SUMMARY

In order to solve the problems in the above background, the present disclosure provides a handheld hot stamping apparatus, which connects with clothing by heating the hot stamping label. The handheld hot stamping apparatus includes a heating plate, a heat-conducting plate, and a connecting piece. The connecting piece connects the heating plate and the heat-conducting plate, and also allows the heat-conducting plate to be detached from the state of being connected to the heating plate; the melting temperature required for the hot stamping label is provided by the heating plate, which transfers the temperature to the hot stamping label through the heat-conducting plate. After manually holding the hot stamping apparatus until the hot melt adhesive of the hot stamping label is completely melted, or placing the hot stamping apparatus beside the workbench and waiting for the hot melt adhesive of the hot stamping label to be completely melted, the heat-conducting plate and the hot stamping label are pressed on the clothing. Meanwhile, the heating-conducting plate falls off, and the hot stamping label attached to the heat-conducting plate is physically connected to the clothing; the main purpose is to wait for the hot melt adhesive of the hot stamping label to cool down so that the hot stamping label can be fixed on the clothing.

Unvulcanized silica gel is applied to a heat-conducting plate engraved with text and patterns. The heating plate provides temperature and the heat-conducting plate transmits the temperature. Then the heat-conducting plate and the hot stamping label are pressed on the clothing by a handheld hot stamping apparatus; meanwhile, the heat-conducting plate falls off, after falling off, the heat-conducting plate and the first vulcanized silica gel are left on the clothing. After the first vulcanization and cooling, the silica gel is fixed on the clothing to form a mark.

The aforementioned manual handheld hot stamping apparatus can reconnect a new heat-conducting plate after the heat-conducting plate falls off; the heat-conducting plate plays a role in stabilizing the hot stamping label on the clothing to a certain extent, solving the problems of low efficiency and difficulty in stably achieving the hot stamping the complete hot stamping label by individual DIY operations.

In order to achieve the above objectives, the present disclosure provides the following technical solutions: A handheld hot stamping apparatus includes a housing provided with a heating plate and a power supply assembly inside, where the power supply assembly provides electric energy for the heating plate, and the outside is used for a user to hold; where the heating plate is configured to provide heat as a heat-conducting plate; and where the heat-conducting plate is provided with a heat-conducting plate adhesive on one side, and a hot stamping label is bonded by the heat-conducting plate adhesive, and sufficient heat to melt a hot melt adhesive of the hot stamping label is transferred to the hot stamping label; and a connecting piece configured to lock and/or separate the heating plate and the heating-conducting plate.

Preferably, the hot stamping label includes a release film, a silica gel, and a hot melt adhesive that are stacked in sequence, the release film is configured to be bonded to the heat-conducting plate by means of the heat-conducting plate adhesive; the silica gel is configured to be a text or graphic logo style; the hot melt adhesive is configured to be heated and melted by the heat transferred by the heat-conducting plate, and is pressed against the clothing by the heat-conducting plate, and the silica gel is connected to the clothing after the hot melt adhesive cools down.

A handheld hot stamping apparatus includes a housing and a power supply, a heating plate is provided on the housing; the heating plate transfers heat to a heat-conducting plate; the heat-conducting plate is provided with a heat-conducting plate adhesive, and the heat-conducting plate adhesive bonds with a hot stamping label.

The handheld hot stamping apparatus further includes a connecting piece, which locks and/or separates the heating plate and the heat-conducting plate.

Preferably, the hot stamping label includes a heat-conducting plate adhesive, a release film, a silica gel and a hot melt adhesive stacked in sequence; the heat-conducting plate adhesive bonds the heat-conducting plate and the hot stamping label; the release film bonds with the heat-conducting plate adhesive; the silica gel is in a logo style; the hot melt adhesive is heated by the heat transferred by the heat-conducting plate and then melted, after cooling, the silica gel is connected to the clothing.

A handheld hot stamping apparatus includes a housing and a power supply. A heating plate is provided on the housing; the heating plate transfers heat to a heat-conducting plate; a logo style is printed on the heat-conducting plate; the device further includes an unvulcanized silica gel, which is filled into the logo style of the heat-conducting plate.

The handheld hot stamping apparatus further includes a connecting piece, which locks and/or separates the heating plate and the heat-conducting plate.

Preferably, the connecting piece is a clamping mechanism, which is arranged on the housing or the heat-conducting plate, and the other end of the connecting piece buckles the heat-conducting plate or the housing. The clamping mechanism is manually opened to separate the heat-conducting plate from the heating plate.

Preferably, an elastic member is provided on the housing, one end of the elastic member supports an upper housing, and the other end of the elastic member is connected to a lower housing.

Preferably, the connecting piece is a clamping mechanism. The clamping mechanism is arranged on the housing or the heat-conducting plate, the other end of the clamping mechanism buckles the heat-conducting plate or the housing. The housing is held and pressed against the surface of an object, so that the connecting piece is opened and the heat-conducting plate is separated from the heating plate.

Preferably, the clamping mechanism includes a protrusion and a hinge, the housing or the heat-conducting plate is hinged by the hinge, the housing or the heat-conducting plate is provided with a corresponding groove. When the housing is held and pressed against the surface of an object, the elastic member contracts, the protrusion is misaligned with the groove, the connecting piece is automatically opened to separate the heat-conducting plate from the heating plate.

Preferably, the clamping mechanism includes a nut clamping piece or a latch piece, the clamping piece or the latch piece is manually opened to separate the heat-conducting plate from the heating plate.

Preferably, the clamping mechanism includes a motor, a switch, and a clamp. When the switch is turned on, the motor drives the clamp to open automatically, so that the heat-conducting plate is separated from the heating plate.

Compared with the prior art, the present disclosure can achieve the following beneficial effects.

In the present disclosure, the hot stamping label or unvulcanized silica gel is heated and melted by the melting temperature transferred from the heating plate and heat-conducting plate of the handheld hot stamping apparatus, so that the hot stamping label or unvulcanized silica gel is physically connected to the clothing; after locked or separated by the connecting piece, the handheld hot stamping apparatus only needs to be equipped with a plurality of heat-conducting plates to achieve hot stamping of various logo styles. The hot stamping label or the unvulcanized silica gel is first heated and melted, and then separated from the handheld hot stamping apparatus onto the clothing. The heat-conducting plate is separated together to play a certain role in shaping the logo. After waiting for the temperature to cool down, the heat-conducting plate can be used to hot stamp a new logo pattern again.

### BRIEF DESCRIPTION OF THE DRAWINGS

FIG. 1 is an exploded view of a handheld hot stamping apparatus in accordance with some embodiments of the present disclosure.

FIG. 2 is a schematic diagram of a connecting piece of the handheld hot stamping apparatus in accordance with some embodiments of the present disclosure.

FIG. 3 is a three-dimensional schematic diagram of the handheld hot stamping apparatus in accordance with some embodiments of the present disclosure.

FIG. 4 is a schematic A-A cross-sectional view of the handheld hot stamping apparatus in accordance with some embodiments of the present disclosure.

FIG. 5 is a schematic B-B cross-sectional view of the handheld hot stamping apparatus in accordance with some embodiments of the present disclosure.

Reference numerals: housing 2; upper housing 101; lower housing 102; groove 103; heating plate 2; connecting piece 3; hinge 301; protrusion 302; heat-conducting plate 4; elastic member 5; elastic bar 501; spring 502.

### DETAILED DESCRIPTION

The technical solutions in the embodiments of the present disclosure will be clearly and completely described below with reference to the accompanying drawings in the embodiments of the present disclosure. Obviously, embodiments described are only a part of embodiments of the present disclosure, and are not all of embodiments thereof. All other embodiments obtained by persons of ordinary skill in the art based on the embodiments of the present disclosure without creative efforts shall fall within the protection scope of the present disclosure.

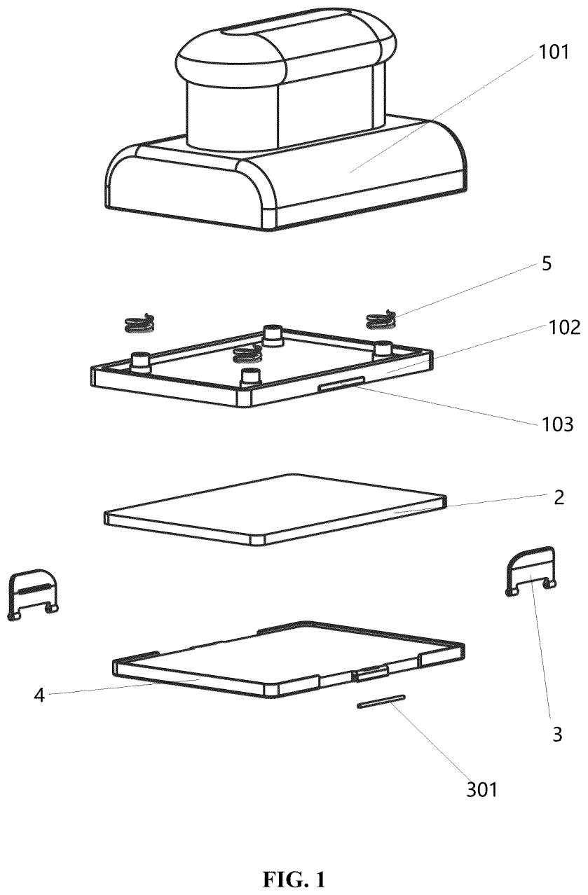

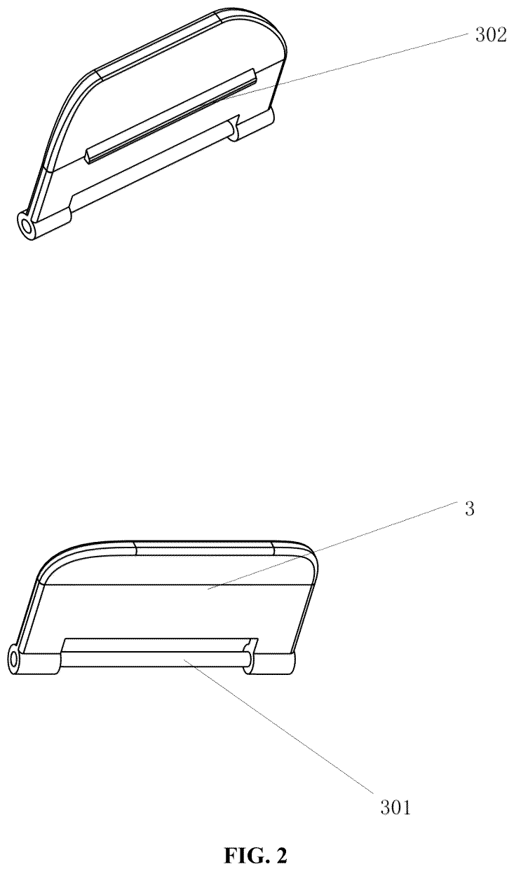

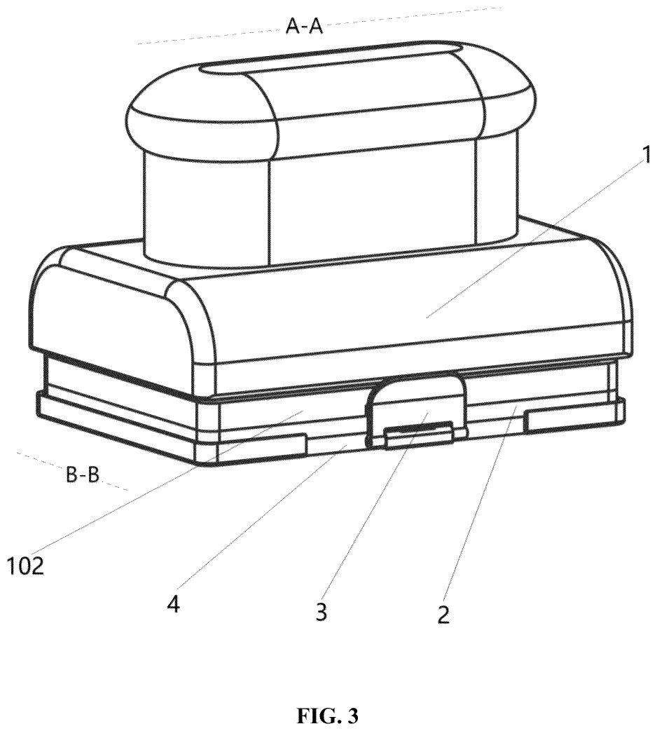

As shown in FIGS. 1 to 5, in some embodiments of the present disclosure, it provides a handheld hot stamping apparatus, including a housing 1 and a power supply. The housing 1 is provided with a heating plate 2, and the housing includes an upper housing 101 and a lower housing 102. The heating plate 2 is arranged on the lower housing 102 and is close to the heat-conducting plate 4. Certainly, the heating plate 2 and the housing 1 are fixedly connected; the heating plate 2 transfers heat to the heat-conducting plate 4; the heat-conducting plate adhesive bonds with the hot stamping label. The handheld hot stamping apparatus further includes a connecting piece 3, the connecting piece 3 locks and or separates the heating plate 2 and the heat-conducting plate 4; the hot stamping label includes a release film, a silica gel, and a hot melt adhesive stacked in sequence, and the release film bonds with the heat-conducting plate adhesive; the silica gel is in a logo style; the hot melt adhesive is heated by the heat transferred by the heat-conducting plate 4 and then melted, after cooling, the silica gel is connected to the clothing.

As shown in FIGS. 1 to 5, in some embodiments of the present disclosure, it provides a handheld hot stamping apparatus, including a housing 1 and a power supply. The housing 1 is provided with a heating plate 2, and the housing includes an upper housing 101 and a lower housing 102. The heating plate 2 is arranged on the lower housing 102 and is close to the heat-conducting plate 4. Certainly, the heating plate 2 and the housing 1 are fixedly connected; the heating plate 2 transfers heat to the heat-conducting plate 4; the heat-conducting plate 4 is provided with a heat-conducting plate adhesive, the heat-conducting plate adhesive bonds with the hot stamping label. The handheld hot stamping apparatus further includes a connecting piece 3, the connecting piece 3 locks and or separates the heating plate 2 and the heat-conducting plate 4; the hot stamping label includes a heat-conducting plate adhesive, a release film, a silica gel, and a hot melt adhesive stacked in sequence, the heat-conducting plate adhesive bonds the heat-conducting plate 4 and the hot stamping label; the release film bonds with the heat-conducting plate adhesive; the silica gel is in a logo style; the hot melt adhesive is heated by the heat transferred by the heat-conducting plate 4 and then melted, after cooling, the silica gel is connected to the clothing.

As shown in FIGS. 1 to 5, in some embodiments of the present disclosure, it provides a handheld hot stamping apparatus, including a housing 1 and a power supply; the housing 1 is provided with a heating plate 2, and the housing includes an upper housing 101 and a lower housing 102, the heating plate 2 is arranged on the lower housing 102 and is close to the heat-conducting plate 4. Certainly, the heating plate 2 and the housing 1 are fixedly connected; the heating plate 2 transfers heat to the heat-conducting plate 4; a logo style is printed on the heat-conducting plate 4. The handheld hot stamping apparatus further includes an unvulcanized silica gel, and the silica gel is filled into the logo style of the heat-conducting plate 4. The handheld hot stamping apparatus further includes a connecting piece 3, the connecting piece 3 locks and or separates the heating plate 2 and the heat-conducting plate 4; the connecting piece 3 is a clamping mechanism, which is arranged on the housing 1 or the heat-conducting plate 4, and the other end of the connecting piece buckles the heat-conducting plate 4 or the housing 1; the clamping mechanism is manually opened to separate the heat-conducting plate 4 from the heating plate 2.

When automatically separating the heating plate 2 from the heat-conducting plate 4, an elastic member 5 can be provided in the housing 1. One end of the elastic member 5 supports the upper housing 101 and the other end of the elastic member is connected to the lower housing 102. The clamping mechanism includes a protrusion 302 and a hinge 301. The housing 1 or the heat-conducting plate 4 is hinged by the hinge 301. The housing 1 or the heat-conducting plate 4 is provided with a corresponding groove 103. When the housing 1 is held and pressed against the surface of an object, the elastic member 5 contracts and the housing 1 moves downward as a whole, the groove 103 on the housing 1 is misaligned with the protrusion 302, the connecting piece 3 is automatically opened to separate the heat-conducting plate 4 from the heating plate 2. Specifically, the heat-conducting plate 4 is kept away from the housing 1 and the heating plate 2.

When manually separating the heating plate 2 from the heat-conducting plate 4, the connecting piece 3 is a clamping mechanism. The clamping mechanism is arranged on the housing 1 or the heat-conducting plate 4, and the other end of the clamping mechanism buckles the heat-conducting plate 4 or the housing 2. The housing 1 is held and pressed against the surface of an object, so that the connecting piece 3 is opened and the heat-conducting plate 4 is separated from the heating plate 2; the clamping mechanism includes a nut clamping piece and a latch piece. The connecting piece 3 is manually opened to separate the heat-conducting plate 4 from the heating plate 2. Specifically, the heat-conducting plate 4 is kept away from the housing 1 and the heating plate 2.

In order to save the costs, when the connecting piece 3 separates the heating plate 2 from the heat-conducting plate 4, the housing 1 can be pressed to move the housing 1 slightly downward by virtue of the flexibility of the housing 1 itself, and then the connecting piece 3 is pushed so that the protrusion 302 leaves the groove 103. The connecting piece 3 manually separates the housing 1 from the heat-conducting plate 4, so that the heat-conducting plate 4 is kept away from the housing 1 and the heating plate 2;

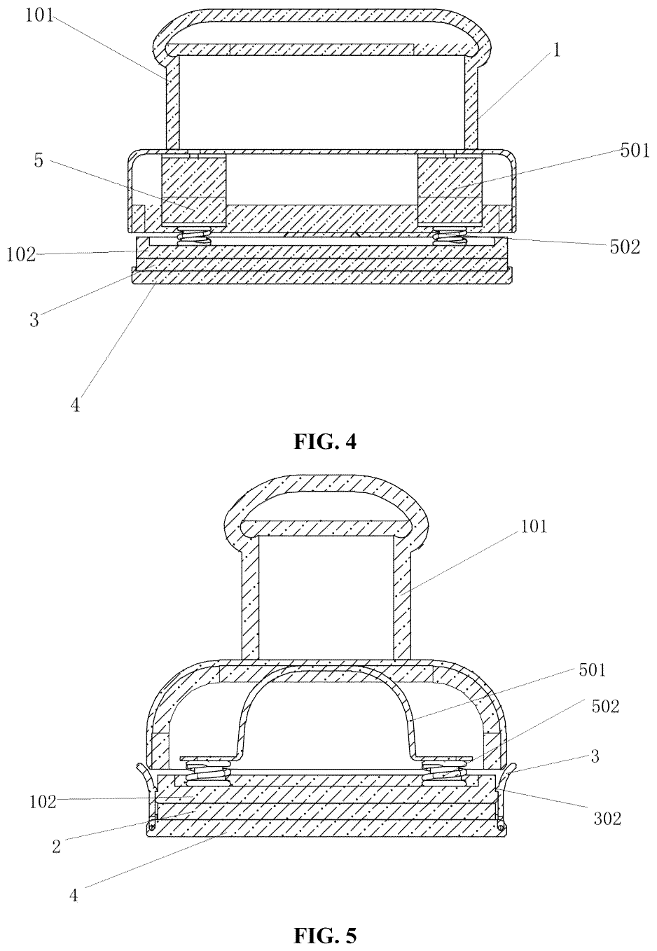

As shown in FIG. 5, of course, the automatic separation fully utilizes the flexibility of the upper housing 101 itself to squeeze the protrusion 302 of the connecting piece 3, which is a fastener, from the groove 103 to form a misalignment, so that the heating plate 2 is automatically separated from the heat-conducting plate 4. Of course, the effect of this implementation is not particularly good.

As shown in FIG. 5, an elastic member 5 can also be provided for automatic separation so that the heat-conducting plate 4 and the heating plate 2 pressed against the surface of the object are automatically separated by misalignment of the connecting piece 3. Specifically, the elastic member 5 is composed of an elastic bar 501 and a spring 502. The elastic bar 501 is arranged on the spring 502, and the spring 502 is sleeved on the limiting column of the lower housing 102. After the upper housing 101 is pressed, the elastic bar 501 extends to both sides and squeezes the spring 502. The corners of the upper housing 101 squeeze away the connecting piece 3, and the protrusion 302 of the connecting piece 3 leaves the groove 103 to form a misalignment, so that the heating plate 2 is automatically separated from the heat-conducting plate 4. Of course, the elastic member 5 may be a special device, for example, a magnetic disconnection device. Specifically, the connecting piece 3 is a magnet, and the magnetism of the connecting piece is eliminated by the magnetic force of the elastic member 5, so that the heat-conducting plate 4 is separated from the heating plate 2. Such several automatic separation methods are not described one by one. It should be clear that, when the connecting piece 3 connects the heating plate 2 and the heat-conducting plate 4, it is to enable temperature transfer; when the connecting piece 3 separates the heating plate 2 and the heat-conducting plate, it is to enable the handheld hot stamping apparatus to connect to other heat-conducting plate 4 again to improve the efficiency of individual DIY operations. Of course, the separated heat-conducting plate 4 is pressed against the hot stamping label or the unvulcanized silica gel to some extent, so as to help the logo style fix its shape on the surface of the object.

The heating plate 2 creates a temperature of 20°-220° to melt the hot melt adhesive, preferably 180°; the silica gel inside the hot stamping label is vulcanized silica gel that has been vulcanized once, so it will not be vulcanized for a second time due to the above temperature.

Regarding the power supply, an external power supply may be used. Wires are provided in the housing 1 to connect the heating plate 2 with the external power supply to provide electric energy to the heating plate 2. The heating plate 2 is made of metal, and the material with a high resistance is the best. Alternatively, a battery is provide in the housing 1 as a power source to provide electric energy to the heating plate 2; of course, a temperature sensor can also be optimally installed in the housing 1, and an external digital temperature control device can be connected to control the heating plate 2 to provide the corresponding melting temperature of the hot stamping label or unvulcanized silica gel.

The heat-conducting plate 4 is made of metal, and aluminum products are the best. When the heating plate 2 and the heat-conducting plate 4 are connected by the connecting piece 3, they are attached together. The heat-conducting plate 4 receives the heat from the heating plate 2 to provide temperature for the hot stamping label or unvulcanized silica gel.

The operating principle and use process of the present disclosure: a hot stamping label or unvulcanized silica gel is connected to clothing by heating; the handheld hot stamping apparatus includes a heating plate 2, a heat-conducting plate 4, and a connecting piece 3. The connecting piece 3 connects the heating plate 2 and the heat-conducting plate 4, and also allows the heat-conducting plate 4 to be detached from the state of being connected to the heating plate 2; the melting temperature required for the hot stamping label is provided by the heating plate 2, which transfers the temperature to the hot stamping label through the heat-conducting plate 4. The heat-conducting plate 4 and the hot stamping label are then pressed onto clothing by a handheld hot stamping apparatus. Meanwhile, the heating-conducting plate 4 falls off, and the hot stamping label attached to the heat-conducting plate 4 is physically connected to the clothing; the main purpose is to wait for the hot melt adhesive of the hot stamping label to cool down so that the hot stamping label is fixed on the clothing.

Unvulcanized silica gel is applied to a heat-conducting plate 4 engraved with text and patterns. The heating plate 2 provides temperature and the heat-conducting plate 4 transmits the temperature. Then the heat-conducting plate 4 and the hot stamping label are pressed on the clothing by a handheld hot stamping apparatus; meanwhile, the heat-conducting plate 4 falls off, after falling off, the heat-conducting plate 4 and the first vulcanized silica gel are left on the clothing. After the first vulcanization and cooling, the silica gel is fixed on the clothing to form a mark.

The aforementioned manual handheld hot stamping apparatus can reconnect a new heat-conducting plate after the heat-conducting plate falls off; the heat-conducting plate 4 plays a role in stabilizing the hot stamping label on the clothing to a certain extent, solving the problems of low efficiency and difficulty in stably achieving the hot stamping the complete hot stamping label by individual DIY operations.

It should be noted that, relational terms used herein such as first and second are only used to distinguish one entity or operation from another entity or operation, and do not necessarily require or imply any such actual relationship or order between these entities or operations. Furthermore, the terms “comprises/comprise”, “includes/include” or any other variants thereof are intended to cover a non-exclusive inclusion such that a process, a method, an article, or an apparatus that includes a series of elements includes not only those elements, but also other elements not explicitly listed, or elements inherent to such process, method, article or apparatus.

Although embodiments of the present disclosure have been illustrated and described, those of ordinary skill in the art will understand that various changes, modifications, and substitutions and variations may be made to these embodiments without departing from the principles and spirit of the present disclosure, and the scope of the present disclosure is defined by the appended claims and equivalents thereof.

What is claimed is:

1. A handheld hot stamping apparatus, comprising a housing provided with a heating plate and a power supply assembly inside;
wherein the power supply assembly provides electric energy for the heating plate, and an outside of the housing is used for a user to hold;
wherein the heating plate is configured to provide heat as a heat-conducting plate;
wherein the heat-conducting plate is provided with a heat-conducting plate adhesive on one side and a hot stamping label is bonded by the heat-conducting plate adhesive, and sufficient heat to melt a hot melt adhesive of the hot stamping label is transferred to the hot stamping label; and
wherein a connecting piece configured to lock or separate the heating plate and the heating-conducting plate.

2. The handheld hot stamping apparatus according to claim 1, wherein the hot stamping label comprises a release film, a silica gel, and a hot melt adhesive that are stacked in sequence, the release film is configured to be bonded to the heat-conducting plate by means of the heat-conducting plate adhesive; the silica gel is configured to be a text or graphic logo style; the hot melt adhesive is configured to be heated and melted by the heat transferred by the heat-conducting plate, and is pressed against the clothing by the heat-conducting plate, and the silica gel is connected to the clothing after the hot melt adhesive cools down.

3. The handheld hot stamping apparatus according to claim 2, wherein the connecting piece is configured as a clamping mechanism, the clamping mechanism is configured to be connected to the housing or the heat-conducting plate at one end, and buckled to the heat-conducting plate or housing at the other hand, and the clamping mechanism is capable of being manually opened to separate the heat-conducting plate from the heating plate.

4. The handheld hot stamping apparatus according to claim 3, wherein an elastic member is provided inside the housing, one end of the elastic member is connected to an upper housing, and the other end of the elastic member is arranged on a limiting column of a lower housing.

5. The handheld hot stamping apparatus according to claim 4, wherein the connecting piece is configured as the clamping mechanism, the clamping mechanism is configured to be connected to the housing or the heat-conducting plate at one end, and buckled to the heat-conducting plate or housing at the other hand, when the upper housing is held and pressed against the surface of an object, the elastic member is squeezed, and the upper housing moves downward, so that the clamping mechanism is opened and the heat-conducting plate is separated from the heating plate.

6. The handheld hot stamping apparatus according to claim 5, wherein the clamping mechanism comprises a protrusion and a hinge, the housing or the heat-conducting plate is hinged by the hinge, the housing or the heat-conducting plate is provided with a corresponding groove, when the housing is held and pressed against the surface of an object, the elastic member contracts, the protrusion is misaligned with the groove, the connecting piece is automatically opened to separate the heat-conducting plate from the heating plate.

7. The handheld hot stamping apparatus according to claim 5, wherein the clamping mechanism comprises a nut clamping piece or a latch piece, the nut clamping piece or the latch piece is manually opened to separate the heat-conducting plate from the heating plate.

8. The handheld hot stamping apparatus according to claim 5, wherein the clamping mechanism comprises a motor, a switch, and a clamp, when the switch is turned on, the motor drives the clamp to open automatically, so that the heat-conducting plate is separated from the heating plate.

9. The handheld hot stamping apparatus according to claim 4, wherein the elastic member comprises an elastic bar and a spring, one end of the elastic bar abuts against the upper housing, the other end of the elastic bar is disposed on the spring, and the spring is sleeved on the limiting column of the lower housing.
